(19) United States
(12) Patent Application Publication
(10) Pub. No.: US 2013/0088638 A1
(43) Pub. Date: Apr. 11, 2013

(54) IMAGING APPARATUS

(71) Applicant: Yuuki Sakaguchi, Tokyo (JP)

(72) Inventor: Yuuki Sakaguchi, Tokyo (JP)

(73) Assignee: SONY CORPORATION, Tokyo (JP)

(21) Appl. No.: 13/613,496

(22) Filed: Sep. 13, 2012

(30) Foreign Application Priority Data
Oct. 6, 2011 (JP) 2011-221689

(51) Int. Cl. H04N 5/238

(52) U.S. Cl. 348/369; 348/E05.028

(57) ABSTRACT

An imaging apparatus includes a housing to and from which an accessory can be attached and detached, a mirror that is placed inside the housing and reflects light entering the housing, a device unit that is placed inside the housing and has an imaging device, the imaging device photoelectrically converting light reflected by the mirror, and a light blocking plate that blocks a part of light going toward the device unit. The light blocking plate can be moved between a light blocking position that blocks a part of light going toward the device unit, and a retracted position in which the light blocking plate is retracted when a predetermined operation is performed on the device unit.

### CROSS-REFERENCE TO RELATED APPLICATION

The present application claims priority from Japanese Patent Application No. JP 2011-221689 filed in the Japanese Patent Office on Oct. 6, 2011, the entire content of which is incorporated herein by reference.

### BACKGROUND

The present technology relates to the technical field of an imaging apparatus. More specifically, the present technology relates to the technical field of making a light blocking plate, which blocks a part of light going toward a device unit having an imaging device, movable to thereby improve the ease of cleaning of the device unit while ensuring a favorable imaging condition.

Some imaging apparatuses such as still cameras include a housing to and from which an interchangeable lens can be attached and detached, and a device unit having an imaging device which is provided inside the housing (see, for example, Japanese Unexamined Patent Application Publication No. 2010-130081). In such imaging apparatuses, the mount opening for the interchangeable lens becomes exposed when the interchangeable lens is detached from the housing. Thus, dust is likely to enter the housing through the mount opening and adhere to the surface of the device unit. When dust adheres to the device unit, the shadow cast by the dust falls on the imaging device, degrading image quality.

The imaging apparatus described in Japanese Unexamined Patent Application Publication No. 2010-130081 removes dust adhering on the surface of the device unit by blowing air onto the surface of the device unit.

Also, in imaging apparatuses, entry of light (hazardous light) that does not contribute to image formation into the device unit causes degradation of image quality. Accordingly, some imaging apparatuses are provided with a light blocking plate that blocks hazardous light that goes toward the device unit.

In such imaging apparatuses provided with a light blocking plate, generally, the light blocking plate is placed near the device unit in order to block hazardous light that goes toward the device unit, without hindering entry of the light (subject light) for producing a subject's image into the device unit.

### SUMMARY

However, in the imaging apparatuses provided with a light blocking plate, when cleaning the dust adhering on the surface of the device unit, the light blocking plate placed near the device unit becomes an obstruction that makes it difficult to blow air onto the surface of the device unit near the light blocking plate, which can lead to a situation where dust is not sufficiently removed from the surface of the device unit.

Accordingly, it is desirable to improve the ease of cleaning of the device unit while ensuring a favorable imaging condition.

According to an embodiment of the present technology, there is provided an imaging apparatus including a housing to and from which an accessory can be attached and detached, a mirror that is placed inside the housing and reflects light entering the housing, a device unit that is placed inside the housing and has an imaging device, the imaging device photoelectrically converting light reflected by the mirror, and a light blocking plate that blocks a part of light going toward the device unit. The light blocking plate can be moved between a light blocking position that blocks a part of light going toward the device unit, and a retracted position in which the light blocking plate is retracted when a predetermined operation is performed on the device unit.

Therefore, in the imaging apparatus, the light blocking plate is located in the light blocking position during shooting to thereby block a part of light going toward the device unit, and is located in the retracted position during a predetermined operation.

According to an embodiment of the present technology, in the imaging apparatus mentioned above, desirably, the light blocking plate can be rotated between the light blocking position and the retracted position.

Since the light blocking plate can be rotated between the light blocking position and the retracted position, the space for movement of the light blocking plate is made small.

According to an embodiment of the present technology, in the imaging apparatus mentioned above, desirably, the retracted position is located on a subject side with respect to the light blocking position.

Since the retracted position is located on the subject side with respect to the light blocking portion, the retracted position is located farther away from the device unit than the light blocking position.

According to an embodiment of the present technology, in the imaging apparatus mentioned above, desirably, the imaging apparatus further includes an urging spring that urges the light blocking plate to at least one side in a direction of movement.

Since the imaging apparatus is provided with an urging spring that urges the light blocking plate to at least one side in the direction of movement, the light blocking plate is urged in the direction of movement by the urging spring.

According to an embodiment of the present technology, in the imaging apparatus mentioned above, desirably, the light blocking plate is urged toward the light blocking position.

Since the light blocking plate is urged toward the light blocking position, the light blocking plate is located in the light blocking position in a state in which no external force is being applied.

According to an embodiment of the present technology, in the imaging apparatus mentioned above, desirably, the imaging apparatus further includes an urging spring that urges the light blocking plate toward the retracted position, and the accessory is provided with a contact projection that comes into contact with the light blocking plate to move the light blocking plate to the light blocking position when the accessory is mounted to the housing.

Since the imaging apparatus is provided with an urging spring that urges the light blocking plate toward the retracted position, and the accessory is provided with a contact projection that comes into contact with the light blocking plate to thereby move the light blocking plate to the light blocking position when the accessory is mounted to the housing, the light blocking plate is moved to the light blocking position when the accessory is mounted to the housing.

According to an embodiment of the present technology, in the imaging apparatus mentioned above, desirably, the light blocking plate is oriented orthogonally to an optical axis in the light blocking position.

Since the light blocking plate is oriented orthogonally to the optical axis in the light blocking position, the light blocking plate blocks more light that goes toward the device unit.

According to an embodiment of the present technology, in the imaging apparatus mentioned above, desirably, the mirror is a semi-transparent mirror that reflects and transmits light entering the housing, and the imaging apparatus further includes an imaging unit that is placed inside the housing and has an image sensor, the image sensor photoelectrically converting light transmitted through the mirror.

Since the mirror is a semi-transparent mirror that reflects and transmits light that enters the housing, and the imaging apparatus is provide with an imaging unit that is placed inside the housing and has an image sensor that photoelectrically converts light transmitted through the mirror, it is possible to generate a plurality of different kinds of data.

According to an embodiment of the present technology, in the imaging apparatus mentioned above, desirably, the imaging device and the image sensor are placed orthogonally to each other.

Since the imaging device and the image sensor are placed orthogonally to each other, the direction of incidence of light on the imaging device and the direction of incidence of light on the image sensor are made orthogonal to each other.

In the imaging apparatus according to an embodiment of the present technology, the light blocking plate is located in the light blocking position during shooting to thereby block a part of light going toward the device unit, and is located in the retracted position during a predetermined operation to thereby avoid interference with the operation. Therefore, it is possible to improve the ease of operation during the predetermined operation on the device unit while ensuring a favorable imaging condition.

### BRIEF DESCRIPTION OF THE DRAWINGS

FIG. 1 illustrates a first embodiment together with FIGS. 2 to 5, and is a schematic perspective view of an imaging apparatus and an interchangeable lens;

FIG. 2 is an enlarged sectional view of an imaging portion;

FIG. 3 is an enlarged perspective view of a light blocking plate in a light blocking position;

FIG. 4 is an enlarged sectional view illustrating a part of a blower and the state of the light blocking plate during cleaning of a device unit;

FIG. 5 is an enlarged perspective view of the light blocking plate in a retracted position;

FIG. 6 illustrates a second embodiment together with FIGS. 7 to 10, and is a schematic perspective view of an imaging apparatus and an interchangeable lens;

FIG. 7 is an enlarged perspective view of a light blocking plate in a retracted position;

FIG. 8 illustrates, together with FIGS. 9 and 10, the state of the light blocking plate when mounting the interchangeable lens to the imaging apparatus, and is a schematic side view illustrating a state at the start of mounting of the interchangeable lens to the imaging apparatus;

FIG. 9 is a schematic side view illustrating a state during mounting of the interchangeable lens to the imaging apparatus;

FIG. 10 is a schematic side view illustrating a state at the completion of mounting of the interchangeable lens to the imaging apparatus; and

FIG. 11 is an enlarged schematic sectional view of an imaging apparatus according to a modification.

### DETAILED DESCRIPTION OF EMBODIMENTS

Hereinafter, embodiments of an imaging apparatus are described with reference to the attached drawings.

In the embodiments below, the imaging apparatus is applied to an interchangeable lens-type still camera.

The scope of applications of the present technology is not limited to an interchangeable lens-type still camera. For example, the present technology can be applied to a wide variety of imaging apparatuses such as an interchangeable lens-type video camera.

In the following description, directions such as front, rear, top (up), bottom (down), left, and right are defined as directions as viewed from the photographer when shooting with the imaging apparatus (still camera). Therefore, the subject side is the front, and the photographer side is the rear.

The directions such as front, rear, top (up), bottom (down), left, and right in the following description are used for the convenience of explanation, and are not intended to limit the present technology to these directions in carrying out the present technology.

### First Embodiment

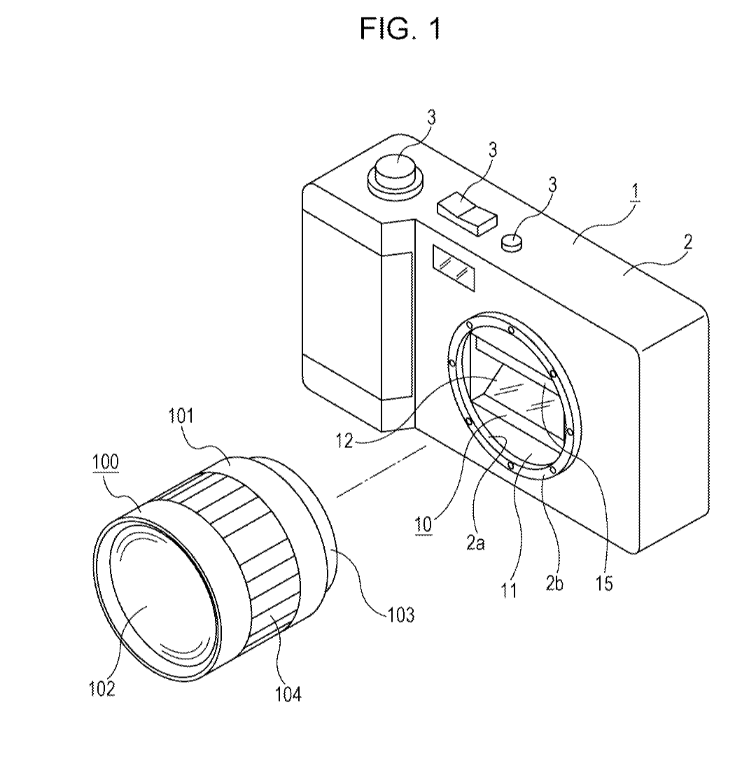

Hereinafter, an imaging apparatus according to a first embodiment, and an interchangeable lens that is attached to and detached from the imaging apparatus are described (see FIGS. 1 to 5).

### [Configuration of the Imaging Apparatus]

An imaging apparatus 1 has various necessary portions placed inside and outside a housing 2 (see FIG. 1). Various operating portions 3 are placed on the outer surface of the housing 2. As the operating portions 3, for example, a power button, a shutter, a zoom switch, a mode selection knob, and the like are provided.

A display panel (not illustrated) such as a liquid crystal panel is provided on the back of the imaging apparatus 1.

An opening 2a is formed on the front of the housing 2. The portion around the opening 2a is provided as a mounting portion 2b for mounting an interchangeable lens 100.

The interchangeable lens 100 is provided as an accessory to be mounted to the imaging apparatus 1, and has a group of lenses including an imaging lens 102 placed inside a lens barrel 101. The rear end of the lens barrel 101 has a portion to be mounted 103 that is mounted to the mounting portion 2b of the housing 2. The portion to be mounted 103 is formed in a ring shape. A zoom ring 104 used for zooming is rotatably supported on the lens barrel 101. Zooming is performed by rotating the zoom ring 104 to move the group of lenses placed inside in the direction of the optical axis.

An imaging portion 10 is placed inside the housing 2.

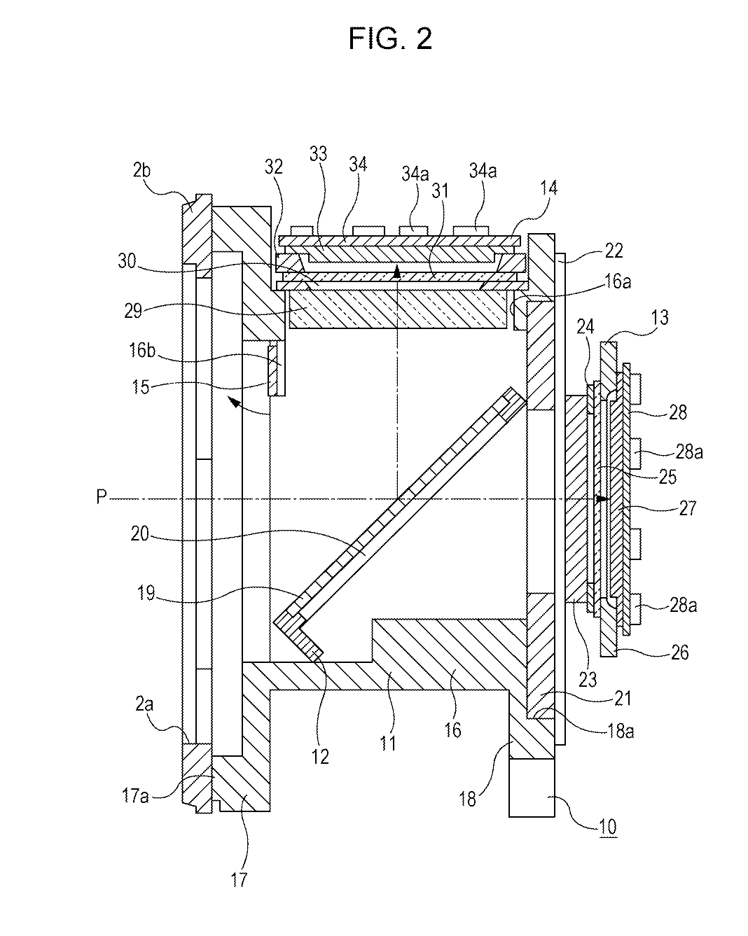

As illustrated in FIG. 2, the imaging portion 10 includes a mirror box 11, a mirror unit 12, an imaging unit 13, a device unit 14, and a light blocking plate 15. The mirror box 11 is mounted in rear of the mounting portion 2b. The mirror unit 12 is placed inside the mirror box 11. The imaging unit 13 is placed in rear of the mirror unit 12. The device unit 14 is placed above the mirror unit 12. The light blocking plate 15 is placed near the front side of the device unit 14.

The mirror box 11 includes a placing portion 16, a front flange 17, and a rear flange 18. The placing portion 16 is formed substantially in the shape of a rectangular tube that is elongated in the front-to-rear direction. The front flange 17 hangs over outwards from the front end of the placing portion 16. The rear flange 18 hangs over outwards from the rear end of the placing portion 16. An insertion hole 16a is formed in the top portion of the placing portion so as to extend through the top portion in the top-to-bottom direction. On the inside of the front end of the top portion of the placing portion 16, a stopper 16b that is projected downward is provided at its one end along the left-to-right direction. A protrusion 17a that is projected forward is provided on the outer circumference of the mounting portion 2b. The protrusion 17a is attached onto the outer circumference of the mounting portion 2b. The rear flange 18 is provided with a placing recess 18a that is open to the rear.

The mirror unit 12 has a mirror 19, and a holding portion 20 that holds the mirror 19 inside the placing portion 16. The mirror 19 is placed so as to be inclined at 45 degrees with respect to an optical axis P that extends in the front-to-rear direction. The mirror 19 is a semi-transparent mirror that reflects and transmits light that is made to enter the housing 2 through the opening 2a. Therefore, a part of the light that is made to enter the housing 2 is transmitted through the mirror 19 to enter the imaging unit 13, and the remainder is reflected upward by the mirror 19 to enter the device unit 14.

The imaging unit 13 includes a shutter 21, a frame member 22, a low-pass filter 23, a spacer 24, an optical member 25, a frame body 26, an image sensor 27, and a substrate 28, which are placed in this order from the front side to the rear side.

The imaging unit 13 is mounted on the mirror box 11 in a state in which the shutter 21 is placed in the placing recess 18a defined in the rear flange 18 of the mirror box 11, with the frame member 22 being in contact with the rear surface of the rear flange 18. At the rear end of the front flange 17, a spring support portion (not illustrated) is provided at the upper opening edge.

The low-pass filter 23 is, for example, infrared ray absorbing glass.

The spacer 24 is formed in a frame-like shape.

The optical member 25 is placed so as to cover the opening of the spacer 24 and the opening of the frame body 26.

The image sensor 27 has the function of converting an optical image into an electrical signal. As the image sensor 27, for example, a charge coupled device (CCD), a complementary metal-oxide semiconductor (CMOS), or the like is used. Image data such as a still image is generated by an electrical signal generated by the photoelectric conversion in the image sensor 27.

A plurality of electronic components 28a are placed on the rear surface of the substrate 28.

The device unit 14 includes a low-pass filter 29, a spacer 30, an optical member 31, a frame body 32, an imaging device 33, and a substrate 34, which are arranged in this order from the lower side to the upper side.

The device unit 14 is mounted to the placing portion 16 in a state in which the low-pass filter 29 is inserted in the insertion hole 16a of the placing portion 16.

The low-pass filter 29 is, for example, infrared ray absorbing glass.

The spacer 30 is formed in a frame-like shape.

The optical member 31 is placed so as to cover the opening of the spacer 30 and the opening of the frame body 32.

The imaging device 33 has the function of converting an optical image into an electrical signal. As the imaging device 33, for example, a CCD, a CMOS, or the like is used. Image data is generated by an electrical signal obtained by converting an optical image by the imaging device 33, and a live-view image or the like is displayed on the display panel. Also, data for detecting a phase difference used to automatically adjust focus during shooting is generated by an electrical signal from the imaging device 33, and the accuracy of focus adjustment is determined on the basis of the data for detecting the phase difference.

The imaging device 33 is placed orthogonally to the image sensor 27 of the imaging unit 13. Therefore, through appropriate placement of the imaging unit 13 and the imaging device 33, miniaturization can be achieved while keeping favorable optical performance.

A plurality of electronic components 34a are placed on the top surface of the substrate 34.

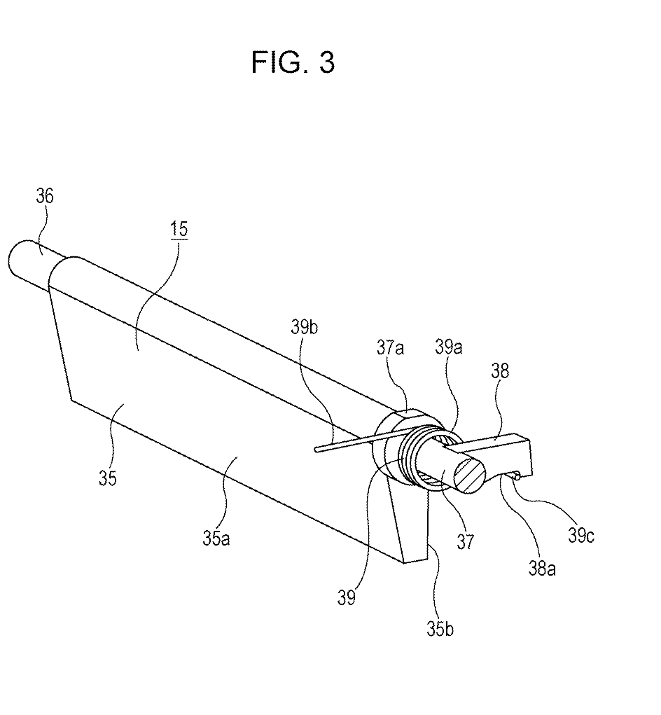

As illustrated in FIG. 3, the light blocking plate 15 includes a light blocking portion 35, a shaft 36, a shaft 37, and a spring locking portion 38 which are formed integrally. The light blocking portion 35 is formed in the shape of a horizontally elongated plate that faces substantially forward and rearward. The shaft 36 extends to the right from the right end of the light blocking portion 35. The shaft 37 extends to the left from the left end of the light blocking portion 35 and is located coaxially with the shaft 36. The spring locking portion 38 is projected from the central portion of the shaft 37 orthogonally to the direction in which the shaft 37 extends. The light blocking plate 15 is supported on the mirror box 11 so as to be rotatable about the shaft 36, 37 as an axis. The light blocking plate 15 is located near the insertion hole 16a on the inside of the front end of the placing portion 16. The light blocking plate 15 has the function of blocking a part of light that goes toward the device unit 14.

One surface of the light blocking portion 35 is formed as a light blocking surface 35a that blocks a part of light going toward the device unit 14. The other surface is formed as an application surface 356 to which a force is applied during rotation.

The right end of the shaft 37 is provided as a large diameter portion 37a that is larger in diameter than the other portion.

A locking recess 38a is formed in the spring locking portion 38.

An urging spring 39 is supported on the light blocking plate 15. The urging spring 39 is, for example, a torsion coil spring. The urging spring 39 includes a coil portion 39a, a first arm 39b, and a second arm 39c.

In the urging spring 39, the coil portion 39a is supported on the portion of the shaft 37 other than the large diameter portion 37a, the first arm 39b is engaged with the spring support portion provided in the front flange 17 of the mirror box 11, and the second arm 39c is engaged with the locking recess 38a of the spring locking portion 38. The right end of the urging spring 39 is in contact with the large diameter portion 37a, thereby preventing contact of the urging spring 39 with the light blocking portion 35.

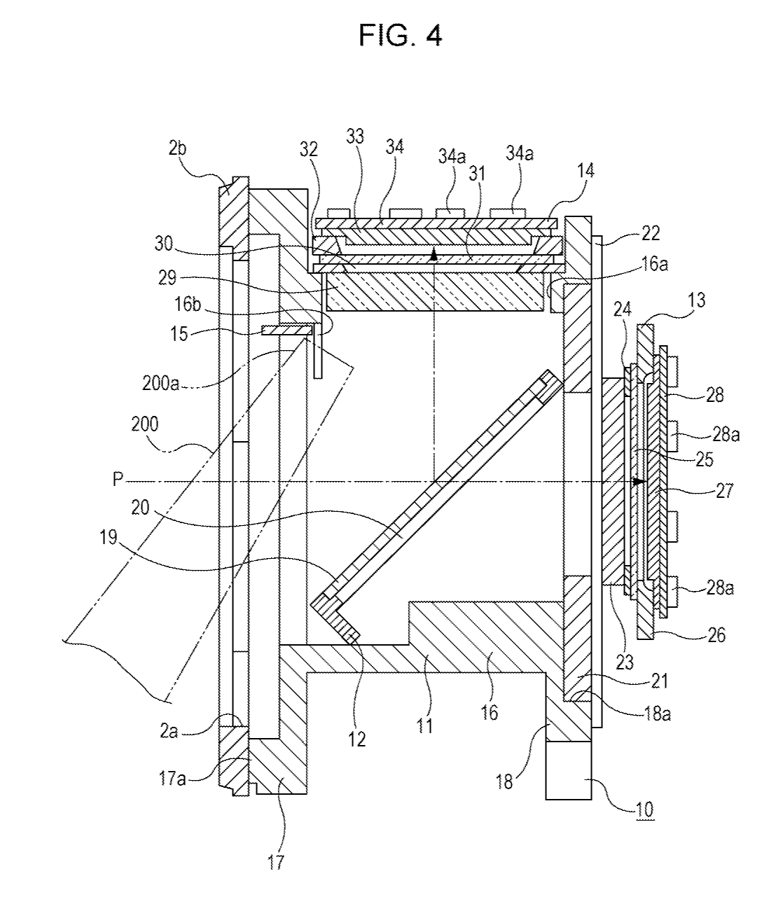

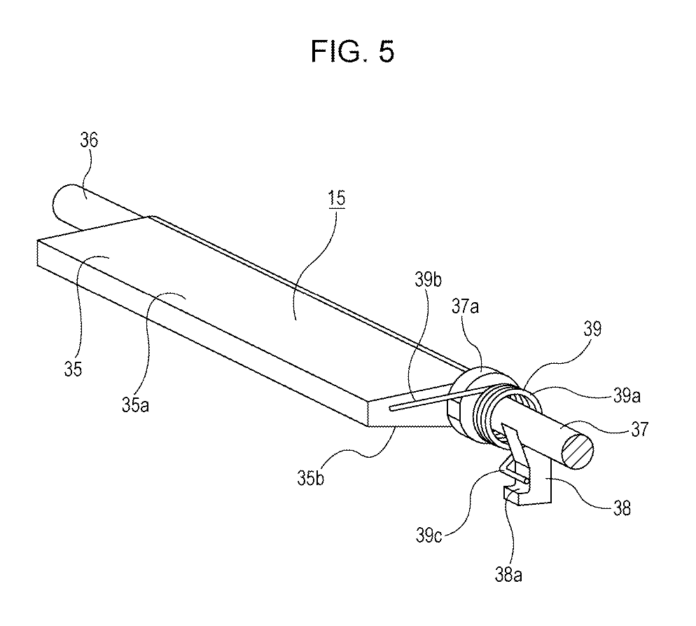

The light blocking plate 15 can be rotated between a light blocking position (see FIGS. 2 and 3) in which the light blocking surface 35a faces substantially forward, and a retracted position (see FIGS. 4 and 5) in which the light blocking surface 35a faces substantially upward during cleaning of the device unit 14.

In the imaging apparatus 1 configured as mentioned above, the light blocking plate 15 is urged by the urging spring 39 from the retracted position toward the light blocking position.

Also, in the imaging apparatus 1 configured as mentioned above, in a state in which no external force is being applied, the light blocking plate 15 is pressed against the stopper 16b of the placing portion 16 and held in the light blocking position by the urging force of the urging spring 39.

### [Cleaning of the Device Unit]

Hereinafter, cleaning performed to remove dust adhering on the device unit 14 in the imaging apparatus 1 configured as mentioned above is described (see FIGS. 2 to 5).

First, the interchangeable lens 100 is detached from the housing 2 of the imaging apparatus 1. At this time, in the imaging apparatus 1, the opening 2a of the housing 2 is exposed, and the light blocking plate 15 is located in the light blocking position (see FIGS. 2 and 3).

Next, a nozzle portion 200a of a blower 200 that sends air by compressing a bag-shaped air-containing portion (not illustrated) is inserted into the housing 2 through the opening 2a. At this time, the nozzle portion 200a of the blower 200 is pressed against the application surface 35b of the light blocking plate 15 (see FIG. 4).

As the nozzle portion 200a is pressed against the application surface 35b of the light blocking plate 15, the light blocking plate 15 is rotated from the light blocking position toward the retracted position against the urging force of the urging spring 39 (see FIG. 5). In a case where the light blocking plate 15 is rotated by only a small amount when the nozzle portion 200a is pressed against the application surface 35b, the light blocking plate 15 may be manually rotated to the retracted position. When the light blocking plate 15 is rotated to the retracted position, the distal end of the nozzle portion 200a is located near the front end of the low-pass filter 29 of the device unit 14.

Next, the air-containing portion of the blower 200 is compressed, and air is blown onto the low-pass filter 29.

As mentioned above, cleaning is performed on the low-pass filter 29 in a state in which the nozzle portion 200a is located near the front end of the low-pass filter 29. Thus, air is blown onto the entire surface of the low-pass filter 29 from the front end to the rear end, and dust adhering on the surface of the low-pass filter 29 is sufficiently removed.

Next, the nozzle portion 200a of the blower 200 is pulled out from the housing 2.

When the nozzle portion 200a is pulled out from the housing 2, the light blocking plate 15 is rotated to the light blocking position by the urging force of the urging spring 39.

As mentioned above, in the imaging apparatus 1, the light blocking plate 15 is urged toward the light blocking position by the urging force of the urging spring 39. Thus, the light blocking plate 15 can be reliably located in the light blocking position at times other than cleaning of the device unit 14. Also, the light blocking plate 15 is located in the light blocking position in a state in which the interchangeable lens 100 is mounted on the housing 2. Thus, a part of light going toward the device unit 14 is blocked at all times during shooting, thereby ensuring a favorable imaging condition.

### Second Embodiment

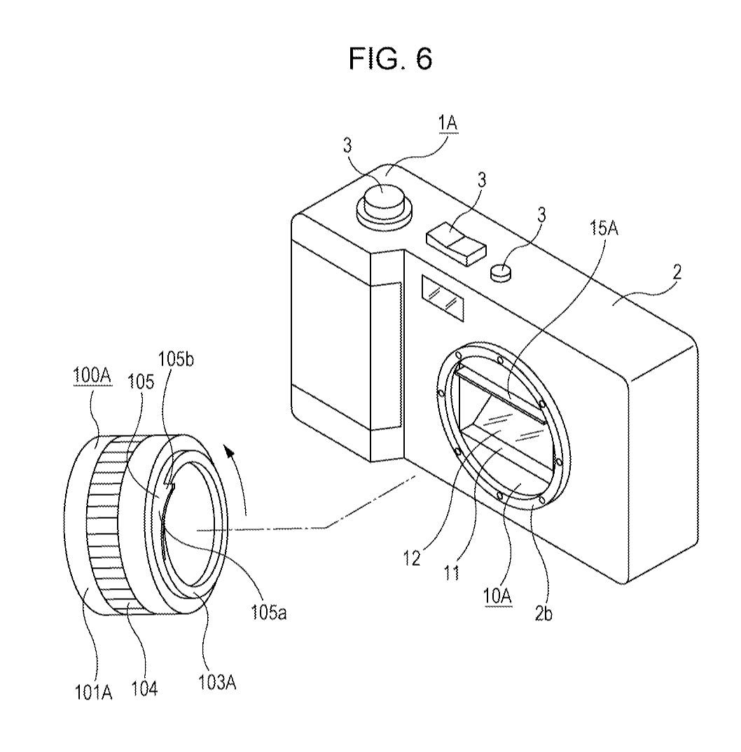

Hereinafter, an imaging apparatus according to a second embodiment, and an interchangeable lens that is attached to and detached from the imaging apparatus are described (see FIGS. 6 to 10).

As compared with the imaging apparatus 1 and the interchangeable lens 100 mentioned above, the imaging apparatus according to the second embodiment and the interchangeable lens attached to and detached from the imaging apparatus described below only differ in that the light blocking plate is urged in the opposite direction by the urging spring, and that the portion to be mounted of the interchangeable lens has a different shape. Therefore, with regard to the imaging apparatus according to the second embodiment and the interchangeable lens attached to and detached from the imaging apparatus, only those portions which differ from those in the imaging apparatus 1 and the interchangeable lens 100 are described in detail, and the other portions are denoted by symbols used for like portions in the imaging apparatus 1 and the interchangeable lens 100 and a description of those portions is omitted.

### [Configuration of the Imaging Apparatus]

As illustrated in FIG. 6, the rear end of a lens barrel 101A of an interchangeable lens 100A is provided with a portion to be mounted 103A. The portion to be mounted 103A is provided with a contact projection 105 that is projected rearward from a part of the outer circumference. The contact projection 105 includes a slope 105a and a hold-down portion 105b. The slope 105a is displaced rearward from one end to the other end in the circumferential direction. The hold-down portion 105b is continuous to the other end of the slope 105a and is projected rearward by the same amount.

An imaging portion 10A of an imaging apparatus 1A includes the mirror box 11, the mirror unit 12, the imaging unit 13, the device unit 14, and a light blocking plate 15A. The light blocking plate 15A is placed near the front side of the device unit 14.

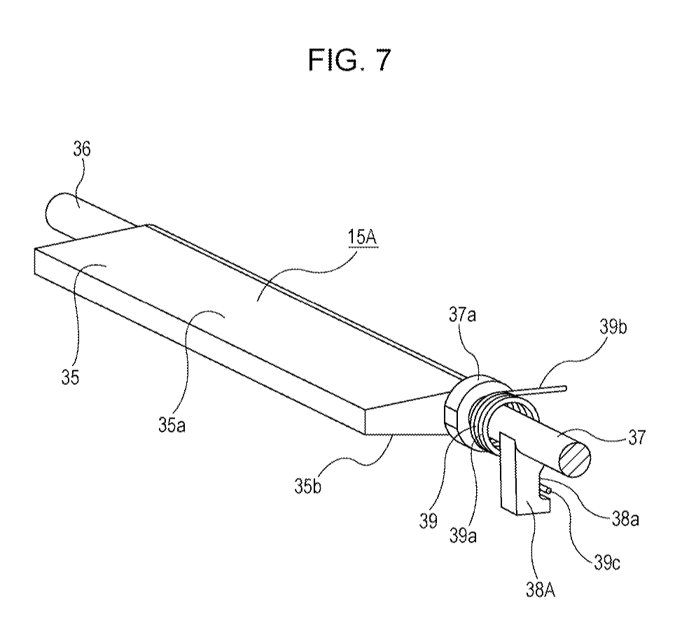

The light blocking plate 15A has the light blocking portion 35, the shaft 36, the shaft 37, and a spring locking portion 38A which are formed integrally. The spring locking portion 38A is projected from the central portion of the shaft 37 orthogonally to the direction in which the shaft 37 extends (see FIG. 7).

In the imaging apparatus 1A configured as mentioned above, the light blocking plate 15A is urged by the urging spring 39 from the retracted position toward the light blocking position.

### [State of the Light Blocking Plate When Mounting the Interchangeable Lens to the Imaging Apparatus]

Hereinafter, with regard to the imaging apparatus 1A configured as mentioned above, the state of the light blocking plate 15A when mounting the interchangeable lens to the imaging apparatus is described.

In a state in which the interchangeable lens 100A is detached from the imaging apparatus 1A to clean the device unit 14, the light blocking plate 15A is pressed by the urging force of the urging spring 39 against the inner surface of the top end at the front end of the mirror box 11 (see FIG. 6). Therefore, the light block plate 15A does not interfere with the nozzle portion 200a of the blower 200 during cleaning. Air is thus blown onto the entire surface of the low-pass filter 29, and dust adhering on the surface of the low-pass filter 29 is sufficiently removed.

When cleaning of the device unit 14 is completed, the interchangeable lens 100A is mounted to the imaging apparatus 1A. The interchangeable lens 100A is mounted to the imaging apparatus 1A by inserting the portion to be mounted 103A of the interchangeable lens 100A into the inside of the mounting portion 2b of housing 2, and rotating the interchangeable lens 100A with respect to the housing 2 to thereby bring the portion to be mounted 103A into engagement with the mounting portion 2b. At this time, the light blocking plate 15A is rotated as described below.

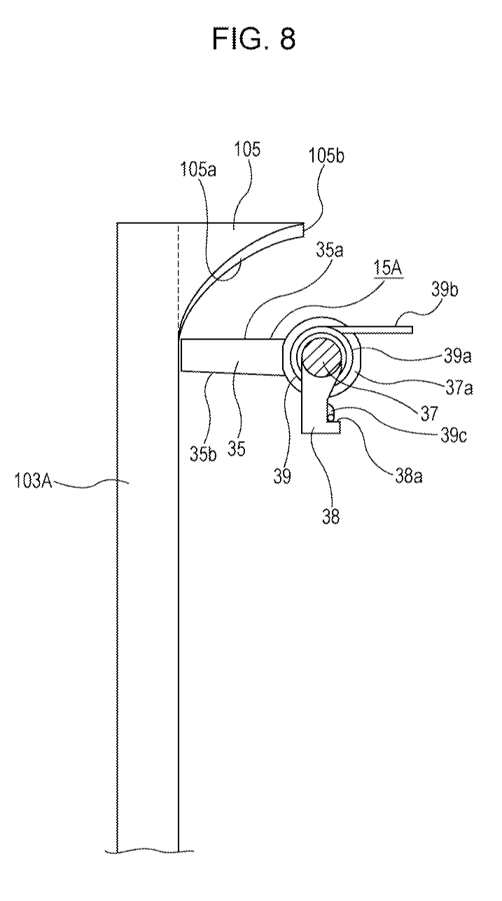

In a state in which the light blocking plate 15A is held in the retracted position, when the portion to be mounted 103A of the interchangeable lens 100A is inserted into the inside of the mounting portion 2b of the housing 2, the contact projection 105 is located above the light blocking plate 15A (see FIG. 8).

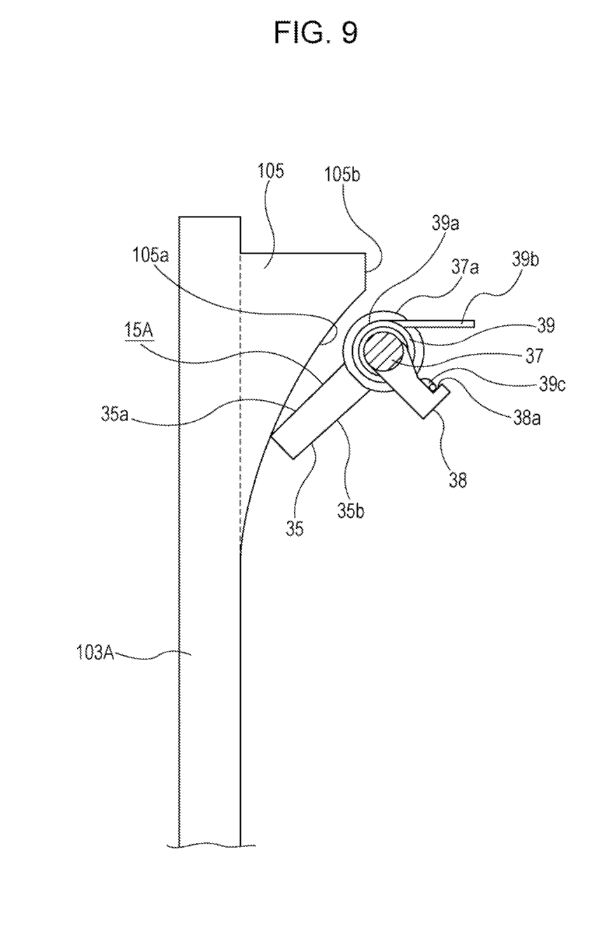

As the interchangeable lens 100A is rotated in a direction that causes the hold-down portion 105b of the contact projection 105 to move downward, the slope 105a of the contact projection 105 is slid against the distal end of the sliding surface 35a of the light blocking plate 15, causing the light blocking plate 15A to rotate from the retracted position toward the light blocking position against the urging force of the urging spring 39 (see FIG. 9).

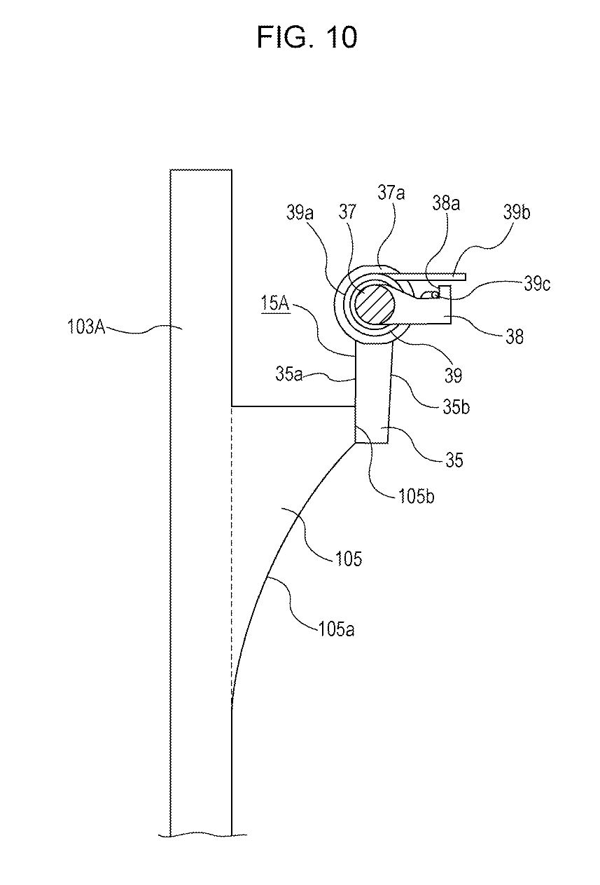

As the interchangeable lens 100A is further rotated and mounted to the imaging apparatus 1A, at the same time, the hold-down portion 105b of the contact projection 105 comes into contact with the light blocking surface 35a, and the light blocking plate 15A is rotated to the light blocking position and held in the light blocking position while being held down in place by the hold-down portion 105b (see FIG. 10).

As mentioned above, in the imaging apparatus 1A, when the interchangeable lens 100A is mounted to the housing 2, the contact projection 105 of the interchangeable lens 100A is brought into contact with the light blocking plate 15A, and the light blocking plate 15A is rotated to the light blocking position.

Therefore, the light blocking plate 15A is rotated to the light blocking position as the interchangeable lens 100A is mounted to the imaging apparatus 1A. Thus, the light blocking plate 15A can be rotated to the light blocking position without any special operation.

Also, in a state in which the interchangeable lens 100A is detached from the imaging apparatus 1A, the light blocking plate 15A is rotated to the retracted position by the urging spring 39. Thus, cleaning can be easily performed with the nozzle portion 200a of the blower 200 without having to rotate the light receiving plate 15A.

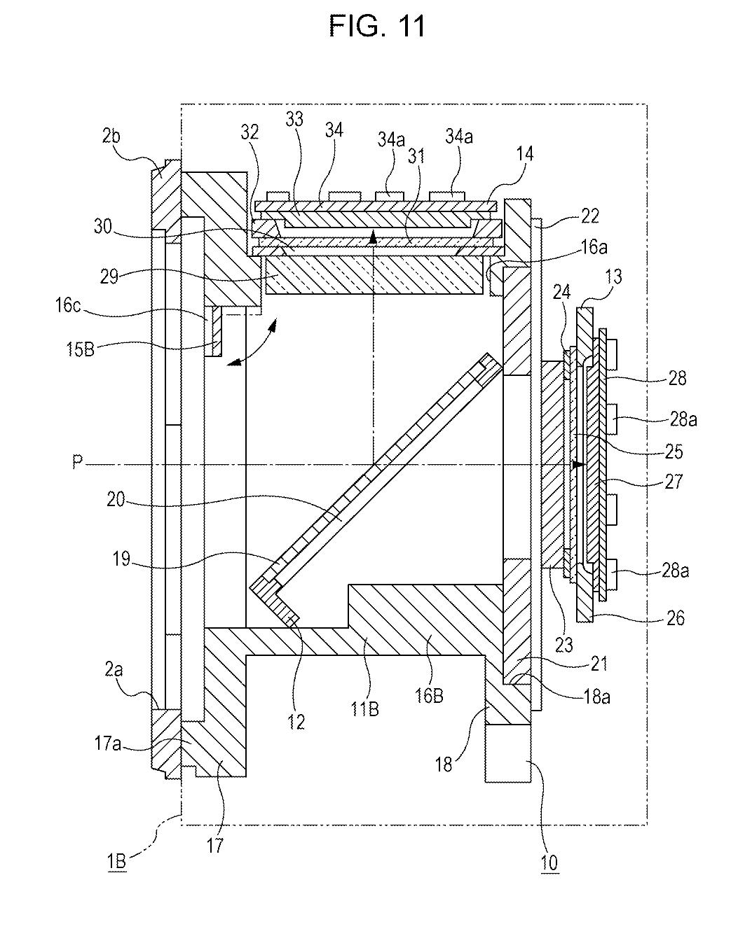

While the above description is directed to the case where the retracted position of the light blocking plate 15 is located on the subject side with respect to the light blocking position in the imaging apparatus 1, it is also possible to configure an imaging apparatus 1B having a light blocking plate 15B whose retracted position is located on the photographer side with respect to the light blocking position as illustrated in FIG. 11. In this case, the light blocking surface 35a of the light blocking plate 15B faces substantially downward in the retracted position, and its rear end is located forward of the device unit 14.

In the imaging apparatus 1B, in a state in which no external force is being applied, the light blocking plate 15B is pressed against a stopper 16c provided at the front end of a placing portion 16B of a mirror box 11B and held in the light blocking position by the urging force of the urging spring 39. Also, in the imaging apparatus 1B, as the nozzle portion 200a of the blower 200 is pressed against the light blocking surface 35a of the light blocking plate 15B, the light blocking plate 15B is rotated from the light blocking position to the retracted position, and cleaning is performed in a state in which the nozzle portion 200a is located near the front end of the low-pass filter 29.

While the above description is directed to the case where the light blocking plate 15, 15A, 15B is rotated in the imaging apparatus 1, 1A, 1B, the light blocking plate may not necessarily be rotated. It suffices that the light blocking plate be moved between the light blocking position that blocks a part of light going toward the device unit 14, and the retracted position in which the light blocking plate is retracted when cleaning of the device unit 14 is performed. For example, the light blocking plate may be moved in the up-and-down or front-to-rear direction between the light blocking position and the retracted position.

Further, while the above description is directed to the case where the interchangeable lens 100, 100A is mounted to the imaging apparatus 1, 1A, 1B by coupling the portion to be mounted 103, 103A to the mounting portion 2b, the interchangeable lens 100, 100A may be also mounted to the housing 2 via an accessory such as an adapter that adjusts the difference in size between the portion to be mounted 103, 103A and the mounting portion 2b.

### [Overview]

As described above, in the imaging apparatus 1, 1A, 1B, the light blocking plate 15, 15A, 15B can be moved between the light blocking position that blocks a part of light going toward the device unit 14, and the retracted position in which the light blocking plate is retracted when cleaning is performed on the device unit 14.

Therefore, the light blocking plate 15, 15A, 15B is located in the light blocking position during shooting to thereby block a part of light going toward the device unit 14, and is located in the retracted position during cleaning to thereby avoid interference with the blower 200. Thus, it is possible to improve the ease of cleaning of the device unit 14 while ensuring a favorable imaging condition.

Also, as mentioned above, the light blocking plate 15, 15A, 15B can be rotated between the light blocking position and the retracted position.

Therefore, as mentioned above, the space for movement of the light blocking plate 15, 15A, 15B can be made small, thereby improving the ease of cleaning while achieving miniaturization.

Further, as mentioned above, the urging spring 39 that urges the light blocking plate 15, 15A, 15B to at least one side in the direction of movement is provided.

Therefore, the light blocking plate 15, 15A, 15B is urged in the direction of movement. Thus, the light blocking plate 15, 15A, 15B can be easily moved to the light blocking position or the retracted position.

Furthermore, as described above, in the imaging apparatus 1, 1A, the retracted position is located on the subject side with respect to the light blocking position.

Therefore, the light blocking plate 15, 15A can be placed close to the device unit 14, thereby achieving miniaturization of the imaging apparatus 1, 1A.

Also, as mentioned above, in the imaging apparatus 1, 1A, 1B, the light blocking plate 15, 15A, 15B is oriented orthogonally to the optical axis in the light blocking position.

Therefore, the light blocking plate 15, 15A, 15B can provide a favorable light blocking condition, thereby ensuring an even more favorable imaging condition.

In addition, as mentioned above, in the imaging apparatus 1, 1A, 1B, the mirror 19 is a semi-transparent mirror, and the imaging apparatus 1, 1A, 1B is provided with the device unit 13 having the image sensor 27 on which light transmitted through the mirror 19 is made incident, and the device unit 14 having the imaging device 33 on which light reflected by the mirror 19 is made incident.

Therefore, it is possible to generate a plurality of different kinds of data on the basis of electrical signals from the image sensor 27 and the imaging device 33, thereby achieving improved functionality.

### [Present Technology]

The present technology can be configured as follows.

(1) An imaging apparatus including a housing to and from which an accessory can be attached and detached, a mirror that is placed inside the housing and reflects light entering the housing, a device unit that is placed inside the housing and has an imaging device, the imaging device photoelectrically converting light reflected by the mirror, and a light blocking plate that blocks a part of light going toward the device unit, wherein the light blocking plate can be moved between a light blocking position that blocks a part of light going toward the device unit, and a retracted position in which the light blocking plate is retracted when a predetermined operation is performed on the device unit.

(2) The imaging apparatus according to (1) mentioned above, wherein the light blocking plate can be rotated between the light blocking position and the retracted position.

(3) The imaging apparatus according to (1) or (2) mentioned above, wherein the retracted position is located on a subject side with respect to the light blocking position.

(4) The imaging apparatus according to any one of (1) to (3) mentioned above, further including an urging spring that urges the light blocking plate to at least one side in a direction of movement.

(5) The imaging apparatus according to (4) mentioned above, wherein the light blocking plate is urged toward the light blocking position.

(6) The imaging apparatus according to any one of (1) to (3) mentioned above, further including an urging spring that urges the light blocking plate toward the retracted position, wherein the accessory is provided with a contact projection that comes into contact with the light blocking plate to move the light blocking plate to the light blocking position when the accessory is mounted to the housing.

(7) The imaging apparatus according to any one of (1) to (6) mentioned above, wherein the light blocking plate is oriented orthogonally to an optical axis in the light blocking position.

(8) The imaging apparatus according to any one of (1) to (7) mentioned above, wherein the mirror is a semi-transparent mirror that reflects and transmits light entering the housing, and the imaging apparatus further includes an imaging unit that is placed inside the housing and has an image sensor, the image sensor photoelectrically converting light transmitted through the mirror.

(9) The imaging apparatus according to (8) mentioned above, wherein the imaging device and the image sensor are placed orthogonally to each other.

The specific shapes and structures of various portions described with reference to each of the embodiments mentioned above are merely an example of embodiment in carrying out the present technology, and are not intended to limit the technical scope of the present technology.

What is claimed is:

1. An imaging apparatus comprising:
a housing to and from which an accessory can be attached and detached;
a mirror that is placed inside the housing and reflects light entering the housing;
a device unit that is placed inside the housing and has an imaging device, the imaging device photoelectrically converting light reflected by the mirror; and
a light blocking plate that blocks a part of light going toward the device unit,
wherein the light blocking plate can be moved between a light blocking position that blocks a part of light going toward the device unit, and a retracted position in which the light blocking plate is retracted when a predetermined operation is performed on the device unit.

2. The imaging apparatus according to claim 1, wherein the light blocking plate can be rotated between the light blocking position and the retracted position.

3. The imaging apparatus according to claim 1, wherein the retracted position is located on a subject side with respect to the light blocking position.

4. The imaging apparatus according to claim 1, further comprising an urging spring that urges the light blocking plate to at least one side in a direction of movement.

5. The imaging apparatus according to claim 4, wherein the light blocking plate is urged toward the light blocking position.

6. The imaging apparatus according to claim 1, further comprising:
an urging spring that urges the light blocking plate toward the retracted position,
wherein the accessory is provided with a contact projection that comes into contact with the light blocking plate to move the light blocking plate to the light blocking position when the accessory is mounted to the housing.

7. The imaging apparatus according to claim 1, wherein the light blocking plate is oriented orthogonally to an optical axis in the light blocking position.

8. The imaging apparatus according to claim 1, wherein:
the mirror is a semi-transparent mirror that reflects and transmits light entering the housing; and
the imaging apparatus further comprises an imaging unit that is placed inside the housing and has an image sensor, the image sensor photoelectrically converting light transmitted through the mirror.

9. The imaging apparatus according to claim 8, wherein the imaging device and the image sensor are placed orthogonally to each other.
